(19) United States
(12) Patent Application Publication
(10) Pub. No.: US 2011/0196748 A1
(43) Pub. Date: Aug. 11, 2011

(54) Generating Advertising Account Entries Using Variables

(76) Inventors: Ilan Caron, New York, NY (US); Ritcha Gupta Ranjan, New York, NY (US); John A. Zeratsky, Chicago, IL (US)

(21) Appl. No.: 12/701,250

(22) Filed: Feb. 5, 2010

(51) Int. Cl. G06Q 30/00; G06F 3/048

(52) U.S. Cl. 705/14.72; 715/764

(57) ABSTRACT

Methods, systems, and apparatus, including computer programs encoded on a computer storage medium, for an advertising account management interface are disclosed. The interface allows a user to define a number of variables and to specify multiple values for each of the variables. The interface also allows the user to create one or more advertising account entry templates (e.g., campaign template, ad group template, advertisement template, and keyword template) by specifying invariable advertising parameters for some input fields of the templates and variable advertising parameters for other input fields of the templates. When the user elects to generate the account entries based on an account entry template, the template is processed to generate multiple unique value combinations defined by the variables used in the template. Each of the unique value combinations corresponds to an account entry generated based on the template the variable values in the unique value combination.

### BACKGROUND

This specification relates to online advertising.

The Internet provides access to a wide variety of resources, such as text, images, videos, audio files, and other multimedia content. Such access has enabled opportunities for targeted online advertising. For example, a query submitted to a search engine can be used as an indicator for the type of information of interest to the user submitting the query; and the query can be compared to advertiser-specified keywords to provide targeted advertisements to the user along with the search results. Likewise, ad slots can be defined on webpages, and advertisements can be statically or dynamically inserted into the ad slots when the webpages are retrieved and rendered in a user's browser. The selection of advertisements can target keywords or topics of the published content on the webpages.

An advertising management system can be used to facilitate the value exchange between advertisers and publishers (e.g., search engines and web content publishers). Advertisers provide advertisements, specify targeting criteria for ad campaigns, and offer bids for the opportunities to have their advertisements presented on publishers' webpages. Online advertisers use advertising management tools to manage their advertising campaigns. These management tools include an account interface that allows an advertiser to create and define various aspects of advertising campaigns and ad groups, such as keywords, targeting criteria, budgets, bids for ad placement, duration, different types of advertisements, and so on. After the advertiser has specified the campaign and ad group data and activated the advertising campaigns and/or ad groups, advertisements can be dynamically selected and served on publishers' webpages according to the various targeting criteria specified by the advertiser.

Currently available account management tools allow an advertiser to duplicate an ad campaign and/or ad group, copy and paste keywords between ad groups, and manually enter modifications to the duplicated ad campaign and/or ad group to create a new ad campaign and/or ad group.

For example, when creating similar ad campaigns using these currently available tools, a user can copy a campaign shell (e.g., all configuration of an ad campaign without ad groups) of an existing ad campaign and use the shell as a basis for a new ad campaign. The user can then copy existing ad groups or ad group shells and paste them into the new ad campaign, copy the keywords and/or advertisements from an existing ad group to paste into a new ad group of the new ad campaign, and so on. The user can then modify particular advertising parameters in the new advertising campaign at various levels (e.g., campaign level, ad group level, advertisement/keyword level, and so on) to create the desired new advertising campaign.

For an advertiser offering a large number of product lines and services, the number of ad campaigns and ad groups tailored for different product lines, market segments, geographic regions, advertising themes, time periods, and so on can easily run into hundreds and thousands. Even though the copy and paste feature in the currently available account management tools help advertisers avoid manually typing in each duplicate advertising parameter when creating new account entries (e.g., ad campaigns, ad groups, ads, and keywords, etc.), the manually duplication of the account entry can still be a time consuming and tedious process. Furthermore, the advertiser still needs to manually enter modifications to particular advertising parameters to tailor each duplicated account entry to a particular advertising need, which is even more tedious, time consuming, and error-prone.

### SUMMARY

This specification describes technologies relating to management of online advertising campaigns.

In general, one innovative aspect of the subject matter described in this specification can be embodied in methods that include the actions of: providing account interface data to a device, the account interface data operable to cause the device to display an account interface, the account interface including a plurality of input fields for user entry of information about an advertising campaign; receiving from the device user input data entered into the plurality of input fields, the user input data specifying invariable advertising parameters and variable advertising parameters for the advertising campaign, each of the variable advertising parameters being defined by one or more variables, and each variable having a plurality of values; receiving selection data from the device, the selection data being generated in response to selection of an account generation option provided by the account interface to generate account entries for the advertising campaign based on the variable and invariable advertising parameters; in response to receiving the selection data, generating a plurality of account entries, each account entry being a unique combination of values defined by the variable and invariable advertising parameters, and wherein the account entries include at least two unique combinations of values for at least one of the variable advertising parameters; and providing account entry data to the device, the account entry data operable to cause the device to display the account entries in the account interface.

Other embodiments of this aspect include corresponding systems, apparatus, and computer programs, configured to perform the actions of the methods, encoded on computer storage devices.

These and other embodiments can each optionally include one or more of the following features.

In some implementations, the invariable advertising parameters and the variable advertising parameters are specified for a campaign level and an ad group level for the advertising campaign, and wherein generating the plurality of account entries includes actions of: generating a variable hierarchy, the variable hierarchy organizing the variables defining the variable advertising parameters in a respective level of the variable hierarchy, the respective level corresponding to the campaign level or the ad group level of the ad campaign; generating unique value combinations based on the variable hierarchy, each value combination including one value from each variable included in the variable hierarchy; and for each of the unique value combinations, generating a corresponding value hierarchy by replacing each variable in the variable hierarchy with a corresponding value in the unique value combination.

In some implementations, the methods further include actions of: providing value hierarchy data to the device, the value hierarchy data operable to cause the device to display the generated value hierarchies; and receiving from the device user input data rejecting one or more of the value hierarchies.

In some implementations, generating the plurality of account entries further includes actions of: for each value hierarchy that is not rejected, generating a respective account entry using the invariable advertising parameters and the variable advertising parameters expressed according to variable values in the value hierarchy, each account entry being a campaign shell including an ad group shell.

In some implementations, the invariable advertising parameters and the variable advertising parameters are specified for a keyword level or an ad level for the advertising campaign, and generating the plurality of account entries further includes actions of: generating unique value combinations, each unique value combination including one of the plurality of values for each variable included in the variable advertising parameters; and for each of the unique value combinations, generating a respective account entry using the invariable advertising parameters and the variable advertising parameters expressed according to the unique value combination, the account entry being a keyword entry or an advertisement entry.

In some implementations, the methods further include actions of: providing variable definition interface data to the device, the variable definition interface data operable to cause the device to display a variable definition interface for managing variables available for use in defining the advertising campaign; and receiving from the device first user input data entered through the variable definition interface, the first user input data specifying the variables and a respective plurality of values for each of the variables.

In some implementations, the account interface further includes respective user interface elements representing the variables available for use in defining the advertising campaign, and the user input data specifying the variable advertising parameters for the advertising campaign includes data indicating user selections of the respective user interface elements representing the variables that define the variable advertising parameters.

Particular embodiments of the subject matter described in this specification can be implemented so as to realize one or more of the following advantages.

The present disclosure relates to an advertising account management interface. The advertising account management interface allows a user to define a number of multi-value variables, and to create one or more account entry templates (e.g., a campaign template, an ad group template, an ad template, a keyword template, etc.) by specifying some of the advertising parameters in the template in terms of one or more of the variables. Therefore, multiple account entries can be generated based on a single account entry template, where each account entry is specified according to a unique combination of the values defined by the variables in the account entry template.

By allowing the user to specify account entry templates using variables and automatically generating multiple account entries based on the templates, the account generation process is simplified when the user has to create a large number of slightly varying account entries (e.g., similar campaigns, ad groups, advertisements, keywords, etc.). The time and repetitive data entry required for individually creating these slightly varying account entries can be reduced; and with the reduction of repetitive data entry, chances for errors can be reduced as well.

Furthermore, the processes and the user interfaces for creating an account entry template are similar to those for creating a single regular account entry (e.g., campaign, ad group, ad, keyword, etc.), and are therefore easier for users adaption.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising environment.

FIG. 2 illustrates the structure of an example advertising account.

FIG. 3 shows an advertising account including example account entries.

FIG. 4 shows an example user interface for defining a variable.

FIG. 5 shows an example user interface for specifying a campaign template.

FIG. 6 shows an example user interface for specifying an ad group template.

FIG. 7 shows an example user interface for reviewing value combinations generated according to the variables used in the campaign and ad group templates.

FIG. 8 shows an example user interface for specifying an ad template.

FIG. 9 shows an example user interface for specifying a keyword template.

FIG. 10 is a flow diagram of an example process for generating multiple account entries using variables.

FIG. 11 is a flow diagram of an example process for presenting campaign and ad group combinations generated using account entry templates and variables.

FIG. 12 is a flow diagram of an example process for generating multiple keywords or advertisements using variables.

FIG. 13 is a flow diagram of an example process for obtaining a variable definition.

FIG. 14 is a block diagram of a programmable processing system.

Like reference numbers and designations in the various drawings indicate like elements.

### DETAILED DESCRIPTION

### I. Online Advertising Environment

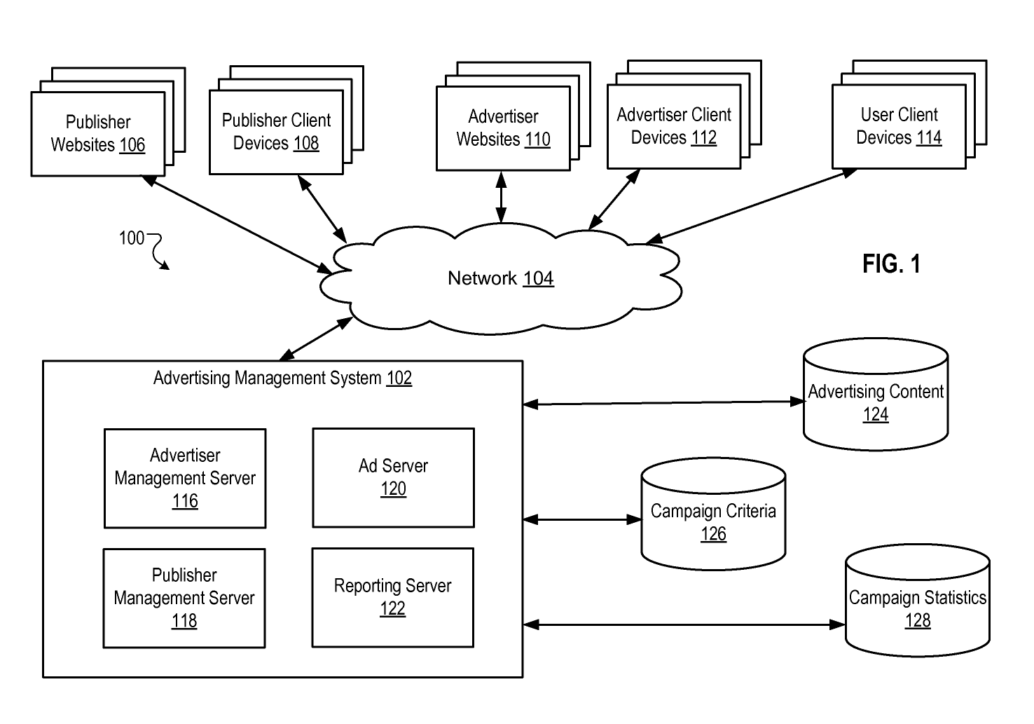

FIG. 1 is a block diagram of an example online advertising environment 100. The online advertising environment 100 utilizes an advertising management system 102 to facilitate the sale and purchase of online advertising opportunities between publishers and advertisers.

The online advertising environment 100 includes a computer network 104, such as a local area network (LAN), wide area network (WAN), the Internet, or a combination thereof, connecting publisher websites 106, publisher client devices 108, advertiser websites 110, advertiser client devices 112, user client devices 114, and the advertising management system 102. The advertising management system 102 further has access to an advertising content store 124, a campaign criteria store 126, and a campaign statistics store 128.

Each publisher website 106 has one or more webpage resources associated with a domain name, and each publisher website 106 is hosted by one or more servers. An example website is a collection of webpages formatted in hypertext markup language (HTML) that can contain text, images, multimedia content, and programming elements, such as scripts. Broadly speaking, an Internet search engine can also be considered as a publisher website, serving dynamically-generated search result webpages in response user-submitted search queries. Each publisher website 106 is maintained by a publisher, e.g., an entity that manages and/or owns the website. For brevity, the term “publisher” will also be used to refer to a website 106 that is managed and/or owned by the publisher. Similarly, websites 110 are maintained by corresponding advertisers, and the term “advertiser” will also be used to refer to a website 110 that is managed and/or owned by an advertiser.

Publisher client devices 108, advertiser client devices 112, and user client devices 114 are electronic devices that are under the control of users and are capable of requesting and receiving data over the network 104. A client device typically includes a user application, such as a web browser, to facilitate the sending and receiving of data over the network 104.

The advertising management system 102 facilitates the sale and purchase of advertising opportunities between publishers 106 and advertisers 110. The advertising management system 102 includes components such as an advertiser management server 116, a publisher management server 118, an ad server 120, and a reporting server 122.

The advertiser management server 116 provides user interfaces for advertisers (e.g., using advertiser client devices 112) to define advertising campaigns and ad groups, submit advertising content, and specify various targeting and/or ad placement criteria for the advertising content in each advertising campaign and/or ad group. The advertising content is stored in the advertising content store 124 and the targeting and ad placement criteria are stored in the campaign criteria store 126. The advertisers can also select particular publishers and/or ad slots and specify bids for those selected ad slots through the interface provided by the advertiser management server 116. Advertisers' bids and selections as well as other campaign related preferences are also stored in the campaign criteria store 128. In some implementations, some of the functions of the advertiser management server can be provided locally by an account management software application executed on the advertiser client device 112, and campaign related data can be communicated to and received from the advertiser management server 116 by the locally executed account management software application on the advertiser client device 112.

The publisher management server 118 provides an interface for publishers (e.g., using publisher client devices 108) to specify ad types and select advertisers and/or products that the publishers wish to advertise for. The publisher management server 118 provides scripts or references to scripts to the publishers according to the specified ad types and the selected advertisers and/or products.

Each publisher 106 can insert scripts (e.g., those provided by the publisher management server 118) into its webpages. When the webpages are downloaded to a user client device 114, the scripts are executed (either locally on the user client device 114 or remotely at a server of the advertising management system 102) to generate one or more ad requests to the advertising management system 102. The ad server 120 of the advertising management system 102 responds to the ad requests by sending advertisements to the requesting user client device 114 for insertion into the publisher's webpages rendered on the requesting user client device 114. The advertisements can include embedded links to landing pages (e.g., webpages on the advertisers' websites 110) that a user is directed to when the user clicks on the advertisements presented on the publisher's webpages.

The ad requests are optionally associated with user characteristics (e.g., user's age, gender, income, search history, language preferences, and so on) and advertising context (e.g., keywords associated with webpage content, location, local time of ad request, and so on). The ad server 120 can select advertisements from the advertising content store 124 for each ad request based on a match between an advertiser's campaign criteria in the campaign criteria store 128 and the user characteristics and advertising context associated with the ad request.

The advertisements provided, and optionally user responses (e.g., click-throughs, conversions, and so on) to the advertisements, are tracked by various tracking mechanisms (e.g., tracking cookies, pixel callbacks, etc.), sent back to the advertising management system 102, and stored in the campaign statistics store 128. The reporting server 122 provides user interfaces for advertisers and publishers to review reports on the campaign statistics in various formats.

### II. Example User Interfaces for Account Entry Generation Using Variables

### II.A. Structure of an Advertising Account

An account management tool can be employed by an advertiser to create and manage a large number of online advertising campaigns for various products and services that the advertiser offers. The account management tool can be made available to the advertiser either through an online interface provided by the advertiser management server 116 or as a account management software application installed and executed locally at the advertiser's client devices 112. The online interface and/or the locally executed account management software application can be used for downloading existing account data from the advertiser management server 116 and for uploading new and/or modified account data to the advertiser management server 116.

In a typical scenario, an advertiser registers an account with the advertiser management server 116. The account is associated with an advertiser ID, authentication information, and billing information of the advertiser. The advertiser can create and manage multiple advertising campaigns using the account management tools offered by the advertising management server 116. The advertiser can further specify multiple ad groups under each ad campaign, and specify respective advertisements, budgets, targeting and/or ad placement criteria, and keywords for each of the ad groups.

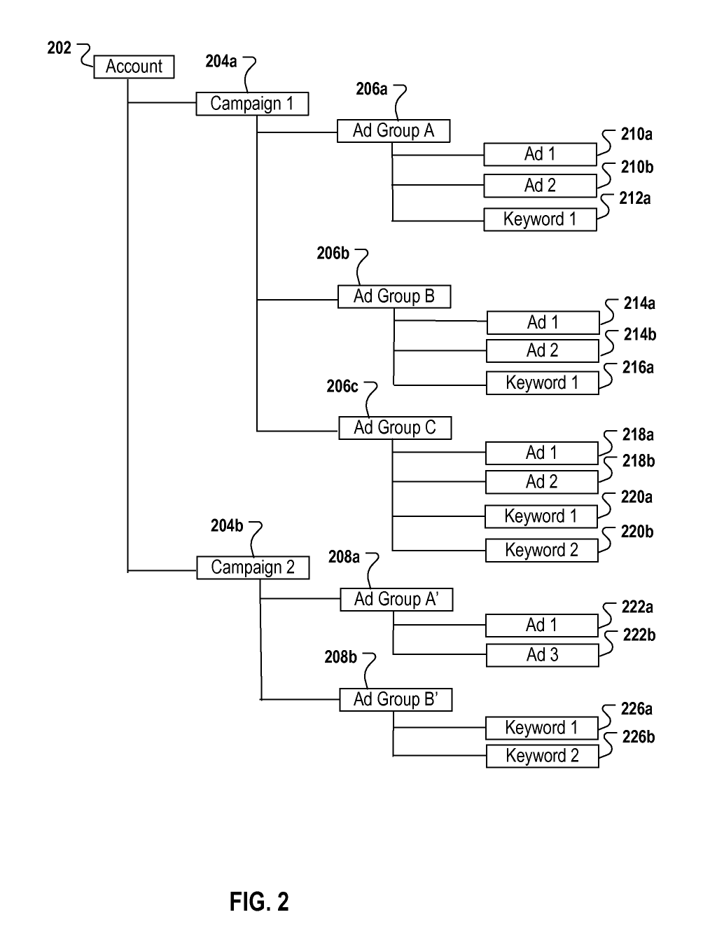

FIG. 2 illustrates the structure of an example advertising account 220 registered at the advertiser management server 116. The advertising account can be abstracted into a hierarchical structure including a root level (e.g., an account level), two intermediate levels (e.g., a campaign level and an ad group level), and a leaf level (e.g., a keyword/advertisement level). Each level of the advertising account hierarchy can include one or more account entries. For example, the campaign level can include one or more ad campaigns, the ad group level can include one or more ad groups for each ad campaign, and the advertisement/keyword level can include one or more advertisements and/or keywords for each ad group. In some implementations, other levels and structures for the advertising account, and other types of account entries for each level of the advertising account can be defined.

In this example, the advertising account 220 includes two ad campaigns (204a and 204b) on the campaign level. Campaign 204a includes three ad groups (206a, 206b, and 206c) on the ad group level, and campaign 204b includes two ad groups (208a and 208b) on the ad group level. Each ad group includes one or more respective advertisements and/or keywords on the advertisement/keyword level of the account structure. For example, ad group 206a of includes ads 210a-b and keyword 212a, ad group 206b includes ads 214a-b and keyword 216a, ad group 206c includes ads 218a-b and keywords 220a-b, ad group 208a includes ads 222a-b and no keywords, and ad group 208b includes keywords 206a-b and no ads.

Each account entry (e.g., a campaign, an ad group, a keyword, an ad, etc.) can be specified by a respective set of advertising parameters through one or more user interfaces provided by the account management tool. For example, a campaign level account entry (e.g., a campaign shell without any specified ad groups) can be specified by campaign-specific values for a set of campaign level advertising parameters, an ad group level account entry (e.g., an ad group shell without any specified advertisements and keywords) can be specified by ad group-specific values for a set of ad group level advertising parameters. An advertisement or keyword can be specified by advertisement-specific or keyword-specific values for a set of ad/keyword level advertising parameters.

### II.B. Example Advertising Parameters for Example Account Entries

To create a new ad campaign, a user can first create a campaign shell by specifying campaign specific values for the campaign level advertising parameters of the ad campaign. The campaign level advertising parameters include, for example, a campaign name, a preferred search network for placing ads on search result webpages, a preferred content network for placing ads on content webpages, a budget for the ad campaign, start and end dates for the ad campaign, a schedule for ad placements, a targeted language, and targeted geographical locations. Other campaign level advertising parameters includes, for example, a payment scheme such as a cost-per-click (CPC), cost per thousand impressions (CPM), cost-per-action (CPA), and so on.

After creating the campaign shell, the user can further define one or more ad groups that share the campaign specific values for the campaign level advertising parameters but have tailored specifications for particular ad group level advertising parameters. New ad groups can be created and added to an existing ad campaign or campaign shell. Alternatively, an existing ad group can be subsequently added to one or more newly created ad campaigns or campaign shells. When an ad group is added to an ad campaign, the ad group can inherit the campaign level parameters of the ad campaign.

To create a new ad group, the user can first create an ad group shell by specifying ad group specific values for the ad group level advertising parameters of the ad group. The ad group level advertising parameters include, for example, an ad group name, and various bids for different ad placement opportunities or outcomes. Placement opportunities include, for example, automatic ad placement in a search result page, automatic ad placement in a content publisher's webpage, advertiser-managed ad placement in a content publisher's webpage, and so on. Ad placement outcomes include, for example, a click-through of an ad, a certain number of impressions of an ad, a specific action performed at the advertiser's site after a click-through of an ad, and so on.

After creating the campaign shell and one or more ad group shells under the campaign shell, the advertiser can specify and add one or more keywords and advertisements to each ad group. The keywords are typically terms that are relevant to the product or services that the user wishes to promote. For example, the car dealership may wish to list “car, vehicle, four-wheel drive, fuel efficiency,” and so on as keywords for their ad groups and ad campaigns. In some cases, negative keywords can be specified by the user to avoid ad placement on certain search result webpages and/or content webpages matching those negative keywords.

Each keyword or group of keywords can be specified by a number of keyword specific advertising parameters. In some cases, a keyword or keyword group can be added to different ad groups and hence inherit different ad group level advertising parameters. Similarly, if the different ad groups also belong to different ad campaigns, the keyword or keyword group may also inherit different campaign level advertising parameters.

In addition to keywords, for each ad group, the advertiser can also specify a number of advertisements for selection by the ad server when an advertising opportunity becomes available and matches the budget, ad schedule, maximum bids, keywords, and targeting criteria specified for the ad group. Different types of ads can be included in an ad group, such as a text ad, an image ad, a local business ad, a mobile ad, and so on.

Each of these advertisements can be specified by a number of advertisement specific advertising parameters. For example, a text ad can be specified by advertising parameters including, a headline (e.g., “Year-End Car Sale”), a short description of a product or service being advertised (e.g., “all lines of trucks, SUVs, and passenger cars 20% off MSRP”), a display URL that conveys a domain name or website name for the advertiser (e.g., “http://www.cars.com”), and a destination URL for a landing page to which a visitor would be directed after a click-through (e.g., “http://www.cars.com/year_end_sale.html”). Text ads can be placed on a search result webpage or a publisher's webpage, for example.

An image ad can be specified by advertising parameters including, for example, a name of the image ad (e.g., “banner ad 1”), a display URL that identifies an address from which the image ad can be retrieved (“e.g., http://www.cars.com/ads/banner_ad1.jpg”), and a destination URL for a landing page to which a visitor would be directed after clicking-through the image ad (e.g., “http://www.cars.com/year_end_sale.html”). An image ad can be presented on a content publisher's webpage, either as a popup or inserted into particular ad slot on the webpage, for example.

A local business ad can be specified by advertising parameters including, for example, a business name (e.g., “Sunnyvale Auto Mall”), an address for the business, a short description of the business, a phone number for the business, a display URL, a destination URL, a map icon, and so on. A local business ad can be displayed on a map displayed on a search result webpage or a location search result webpage, for example.

A mobile ad can be specified by advertising parameters including, for example, a short headline, a short description, a click-to-call phone number, display URL, a destination URL, and so on. A mobile ad can be formatted for and displayed on a mobile device. Other types of ads can be defined, and user interfaces for receiving user input for each kind of ads can be implemented.

Other sub-aspects of the ad group can be defined in terms of various advertising parameters and specified by user-entered values for those various advertising parameters. After the advertiser has specified all the required advertising parameters for each level and aspect of the ad campaign(s), the advertising campaign data (e.g., including the campaign structure and the advertising parameters on each level within the campaign structure) can be uploaded to the account management server 116 where the ad campaign can be created and activated according to the advertising campaign data specified by the advertiser.

### II.C. Creating Multiple Varying Account Entries by Duplication and Modification

Given the large number of advertising parameters that an advertiser can specify for an ad campaign, an ad group, an advertisement, and a keyword, the advertiser can create a large number of similar ad campaigns and ad groups with small variations that tailors to each specific advertising need.

For example, a car dealership can create a different ad campaign for use during each national holiday. The different ad campaigns would likely have the same targeted locations, but different start and end dates. Further, the different ad campaigns may include the same set of ad groups (e.g., an ad group for each type, brand, and model of vehicles), but each ad group may include a set of slightly different ads (e.g., text ads with the same headline “Year-End Sale”, but different descriptions, such as “Toyota cars 20% off MSRP,” “Ford SUV 15% off MSRP,” “Ford trucks $5000 manufacture rebate,” and so on).

For another example, the same car dealership can have different ad campaigns each targeting a different demographic group. Each of these ad campaigns may include the same set of ad groups for the different types, brands, and models of vehicles that the dealership carries. All the ad groups may include the same set of vehicle-related keywords as well. However, the advertiser can specify different maximum bids for some of these keywords for use in different ad campaigns. For example, for an ad campaign targeting people aged 35-45, keywords such as “vehicle safety” and “fuel efficiency” may be given a higher value bid because research showed that people in that age group tended to place more weight on safety and fuel efficiency of a vehicle when considering a purchase. In contrast, keywords such as “SUV” and “hybrid” may be given a higher value bid for the ad campaign targeting people aged 20-35 because research showed that people in this age group tended to be the primary buyers for SUVs and hybrid vehicles.

In accordance with the technologies described herein, an advertiser can define a number of variables and specify multiple values for each variable. Instead of having to create multiple similar account entries one by one, the advertiser can specify an account entry template (e.g., a campaign template, an ad group template, an advertisement template, and/or a keyword template) using the variables. The account entry template (e.g., the campaign template, the ad group template, the advertisement template, the keyword template, etc.) can be specified in a similar way as a corresponding regular account entry (e.g., a campaign, an ad group, an advertisement, a keyword, etc.), except that some of the advertising parameters for the account entry are specified in terms of one or more variables. When the advertiser has completed specifying the account entry template and elects to generate the account entries based on the template, multiple account entries are automatically generated using different values or value combinations of the one or more variables used in the template.

### II.D. Creating Advertising Account Entries Using Variables

### II.D.1. Example Advertising Account for a Car Dealership

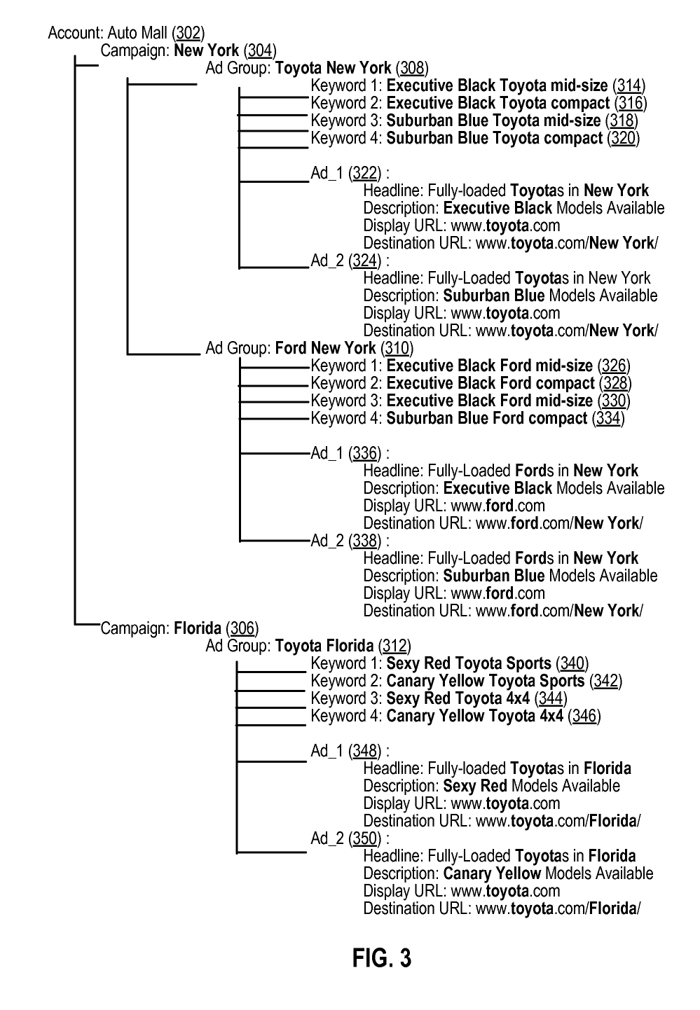

FIG. 3 shows an example advertising account 302 (e.g., account “Auto Mall”) of a car dealership. In this example, the car dealership sells two brands of vehicles (e.g., Toyota and Ford) and in two geographic areas (e.g., New York and Florida). The vehicles also come in different colors (e.g., executive black, suburban blue, sexy red, and canary yellow) and sizes (e.g., compact, mid-size, sports, and 4×4), but not all colors, sizes, and brands are available in all areas. The advertiser wishes to produce slightly different ads that are tailored by vehicle brand, color, size, and available location for use in several ad campaigns for the different geographic areas.

Suppose that the dealership sells both Toyota and Ford vehicles in New York, but only Toyotas in Florida. The car dealership can set up an account structure having two ad campaigns each targeting a respective geographic area (e.g., campaign 304 for New York and campaign 306 for Florida). The car dealership can set up two ad groups under the “New York” campaign 304, one for Toyotas and one for Fords (e.g., ad group 308 for Toyotas sold in New York and ad group 310 for Fords sold in New York). For the “Florida” campaign 306, the car dealership only needs to set up one ad group 312 for the Toyotas sold in Florida.

The keywords and ads for each ad group can have similar formats, but are tailored to the particular brand, color, size, and available location applicable to the vehicles being promoted under the ad group. For example, the keyword groups (e.g., keyword groups 314, 31, 318, and 320) used for the “Toyota New York” ad group 308 under the “New York” campaign 304 include “Executive Black Toyota mid-size,” “Executive Black Toyota compact,” “Suburban Blue Toyota mid-size,” and “Suburban Blue Toyota compact.” The text ads (e.g., ads 322 and 324) used for the same ad group have the following advertising parameters: Headline=“Fully-loaded Toyotas in New York,” Description=“Executive Black Models Available,” “Display URL=www.toyota.com,” and Destination URL=“www.toyotas.com/New York/.” Similarly, the keyword groups (e.g., keyword groups 326, 328, 330, and 333) and ads (e.g., ads 336 and 338) used for the “Ford New York” ad group 310 under the “New York” campaign 304 are almost identical to those used for the “Toyota New York” ad group 308, except that the vehicle brand terms in the keyword groups and ads are switched from “Toyota” to “Ford.”

Similarly, for the ad group “Toyota Florida” 312 in the “Florida” campaign 306, the color, size, and location terms in the keyword groups (e.g., keyword groups 340, 342, 346, and 348) and ads (e.g., ads 348 and 350) are switched from those applicable in the New York campaign (e.g., executive black, suburban blue, mid-size, compact, and New York) to those applicable to the Florida campaign (e.g., sexy red, canary yellow, sports, 4×4, and Florida).

### II.D.2. Defining Variables

Based on the similarities among the desired structure and advertising parameters for the above ad campaigns, ad groups, advertisements and keywords, the advertiser can define a number of variables to represent the bolded terms in the account entries shown in FIG. 3, including, for example, a variable ${Location}=[New York, Florida], and a variable ${Brand}=[Toyota, Ford].

In some implementations, the advertiser can also define campaign specific and/or ad group specific variables that have different values under different ad campaigns and/or ad groups. For example, A campaign specific variable ${Color} can have values [sexy red, canary yellow] under the “Florida” campaign 306, and values [executive black, suburban blue] under the “New York” campaign 304. Similarly, a campaign specific variable ${Size} can have values [Sports, 4×4] under the “Florida” campaign 306, and values [mid-size, compact] under the “New York” campaign 304.

In some implementations, the account management tool can automatically define one or more system variables, for example, based on one or more advertising parameters specified by the user. For example, an ad group specific variable ${CAMPAIGN} can be defined for each ad group, and has a value equal to the name of the campaign including the ad group. Another ad group specific variable ${ADGROUP} can be defined for each ad group, and has a value equal to the name of the ad group in which the variable is used. Other system variables includes, for example, ${KEYWORD}, ${HEADLINE}, ${LINE1}, ${LINE2}, ${DISPLAYURL}, ${DESTINATION URL}, etc. Each of these system defined variables can take on a value that is specific to the keyword and advertisement in which the variable is used. Other variables and variable values can be defined.

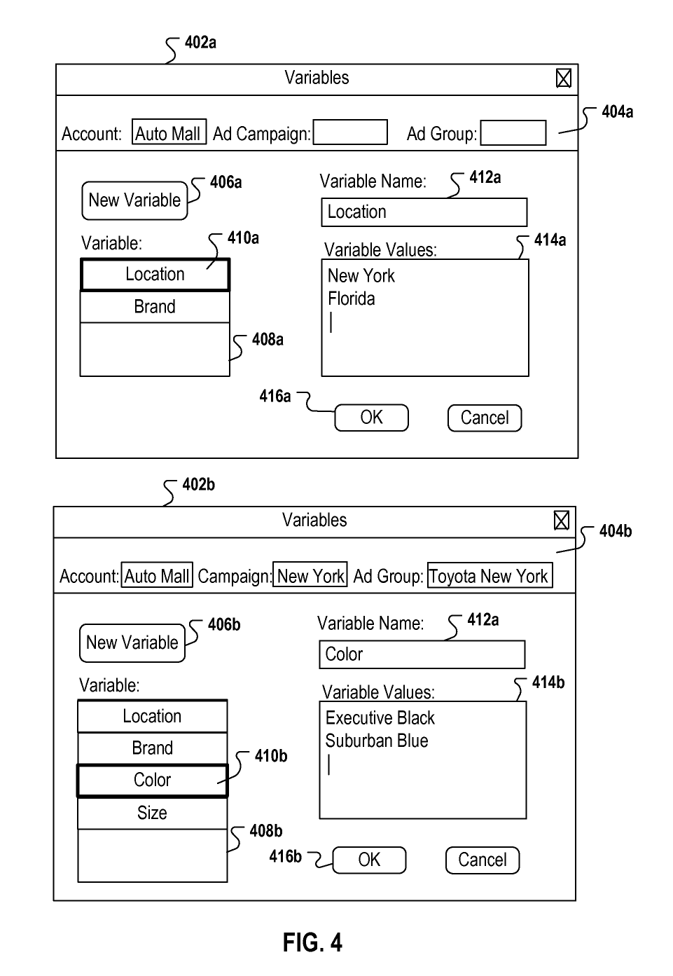

FIG. 4 shows an example variable editing interface 402 for creating and editing variables available for use in an account entry template. The variable editing interface 402 can be invoked for editing variables for the whole advertising account, or a specific ad campaign, ad group, advertisement, or keyword group. For example, user interface element 404 can be used to indicate the specific account, campaign, ad group, advertisement, and/or keyword group for which the variables and variable values shown in the interface 402 are defined.

In this example, user interface element 404a shows that editing interface 402a is for defining the variables and variable values for the whole advertising account “Auto Mall.” User interface element 404b shows that editing interface 402b is for defining the variables and variable values for the “Toyota New York” ad group under the “New York” campaign of the “Auto Mall” account.

In the example, variable editing interface 402 can include a user interface element 406 (e.g., a “New Variable” button). When the user interface element 406 is invoked, the input fields 412 and 414 can be cleared so that the user can enter a new variable name in the variable name field 412, and one or more variable values in the variable value field 414. After the user indicates completion of the variable definition, for example, by invoking user interface element 416 (e.g., an “OK” button), the newly defined variable can be added to the list of existing variables (e.g., in window 408).

In some implementations, the user can select an existing variable to edit its values. For example, by selecting the variable 410a (e.g., the variable ${Location}), the name (e.g., “Location”) and values (e.g., “New York” and “Florida”) of the variable 410a are shown in the input fields 412a and 414a, respectively. The user can add new values and/or delete existing values for the selected variable from the input field 414a. For another example, by selecting the variable 410b (e.g., the ad group specific variable ${Color}), the name (e.g., “Color”) and values (e.g., “Executive Black” and “Suburban Blue”) of the variable 410b are shown in the input fields 412b and 414b.

### II.D.3. Specifying a Campaign Template Using Variables

After the variables are defined, the user can specify a campaign template in terms of one or more variable advertising parameters and one or more invariable advertising parameters. Each invariable advertising parameter can be specified in terms of static text or a selection of one or more static values choices, for example. Each variable advertising parameter can be specified in terms of one or more variables with or without additional static or invariable text input.

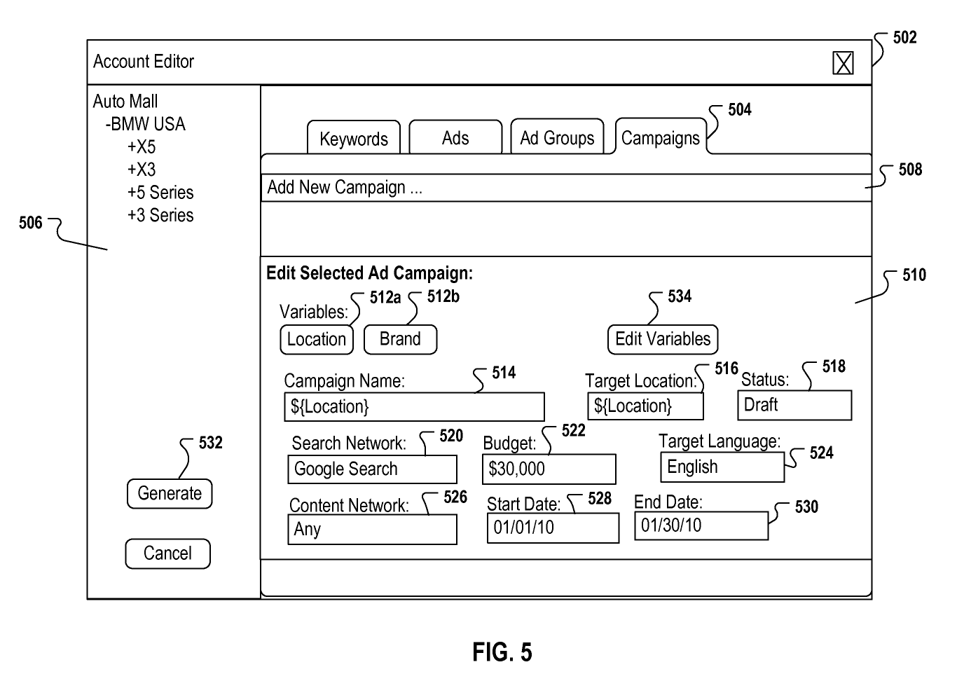

FIG. 5 is an example user interface 504 (e.g., a “Campaign” tab) for specifying a campaign template in an account editor 502. In some implementations, the same user interface 504 can be used to specify a single regular campaign entry if all input fields of the user interface 504 are filled with static or non-variable inputs.

The user interface 504 can include a number input fields (e.g., text fields, radio buttons, check boxes, dropdown menus, etc.) and informational prompts (e.g., description or title for the input fields) for the campaign level advertising parameters of a new ad campaign. Examples of the input fields include: a campaign name field 514, a target location field 516, a status field 518, a search network field 520, a budget field 522, a target language field 524, a content network field 526, a start date field 528, and an end date field 530, as shown in window 510.

In some implementations, the account editor 502 can also display the current structure of the advertising account in a window 506. For example, the advertising account in this example shows a previously created ad campaign “BMW USA” which includes four ad groups “X5,” “X3,” “5 series,” and “3 series.” Each of the ad campaign and ad groups can be expanded to show the account entries below it, for example, when an indicator (e.g., the plus sign) next to the campaign and/or ad group name is invoked. The user can select an existing campaign to review and edit the campaign level advertising parameters for the selected ad campaign in the window 510. Alternatively, the user can create a new ad campaign or campaign template by selecting the user interface element 508, and entering the campaign level advertising parameters in the various input fields shown in the window 510.

To create the campaign template, the user can specify the some of the campaign level advertising parameters as static values (e.g., the status field 518, the search network field 520, the budget field 522, the targeted language field 524, the content network field 526, the start date field 528, and the end date field 530). The user can also specify some of the campaign level advertising parameters in terms of one or more available variables. In some implementations, these available variables can be presented on the user interface 504, for example, as selectable buttons 512a-512b. The advertiser can select the variable “${Location}” for the campaign name field 514, and the target location field 416.

In some implementations, the account editor 502 can also present a user interface element 534 (e.g., an “Edit Variables” button) for editing the variables currently available for use in specifying the campaign template. When the user interface element 534 (the “Edit Variables” button) is invoked from the user interface 504 (e.g., the “Campaign” tab), a variable editing interface (e.g., variable editing interface 402a shown in FIG. 4) can be presented, where the user can add, delete, and/or edit the variables available for use in specifying the campaign template.

After the user has specified the advertising parameter for each required input field in the campaign template, either as static text or selection, in terms of one or more variables, or as combinations of variables and static text, the user can generate multiple campaign shells in the advertising account “Auto Mall” by invoking the user interface element 532 (e.g., a “Generate” button). In some implementations, to generate the multiple campaign shells, the variables used in the campaign template are processed and a number of unique value combinations are generated based on the values of each of the variables. Since only one variable (“${Location}”) is used in the campaign template, the number of unique value combinations is the same as the number of variable values for the variable “${Location}.” One campaign shell can be generated for each unique value combination, and a total of two campaign shells can be generated: one shell having a campaign name and target location of “New York,” and the other having a campaign name and target location of “Florida.” Once the campaign shells have been generated, they can be presented in the window 605 along with other existing ad campaigns.

### II.D.4. Specifying an Ad Group Template Using Variables

In some implementations, the user can proceed to create an ad group or ad group template under the automatically generated campaign shells by selecting the generated campaign shells in the window 605. In some implementations, the advertiser can choose to hold off generating the campaign shells and proceed to create an ad group or ad group template under the campaign template, and then generate the campaign shells and ad group shells together.

Similar to the process for creating the campaign template, the ad group template can be specified using some invariable advertising parameters and some variable advertising parameters. If all ad group level advertising parameters are specified in terms of static values, a regular ad group entry can be created.

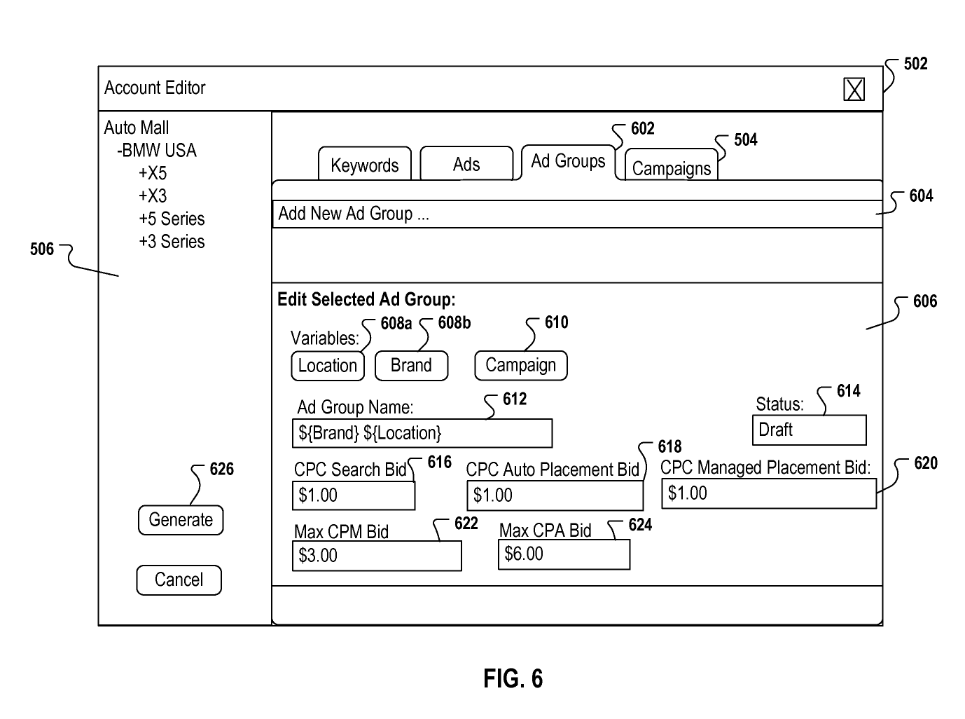

FIG. 6 shows an example user interface 602 (e.g., an “Ad Group” tab) of the account editor 502. In some implementations, the user can choose to create a new ad group or ad group template by selecting the user interface element 604. When the user interface element 604 is selected, a window 606 can be presented for the user to enter the values for the required ad group level advertising parameters for the new ad group. The input fields shown in the window 606 include, for example, an ad group name field 612, a status field 614, a CPC (Cost per Click) search bid field 616, a CPC auto placement bid field 618, a CPC managed placement bid 620, a max CPM (Cost per Thousand Click) bid 622, a max CPA (Cost per Action) bid 624, and so on.

In some implementations, a number of variables available for use in the ad group template can be presented in the window 606, for example, as user interface elements 608a (e.g., for variable ${Location}) and 608b (e.g., for variable ${Brand}). In addition to user defined variables, user interface elements representing one or more system defined variables (e.g., user interface element 610 representing the variable ${Campaign}) can be presented as well. The system defined variables can be based on a variable advertising parameter in the campaign template. For example, the ${Campaign} variable can be defined by the campaign name parameter and associated with the names of all campaigns that can be generated using the current campaign template. In this example, the ${Campaign} variable include two values: “New York” and “Florida.” In some implementations, the user can select additional existing campaigns for the ad group, such that the ad group can be added to those existing ad campaigns as well. In such implementations, the values for the ${Campaign} variable can include the names of the selected ad campaigns as well. In some implementations, the system defined variables are only evaluated

To create the campaign and ad group hierarchy shown in FIG. 3, the user can first specify two ad groups, one ad group for each brand of vehicles, and then eliminate the ad group for Fords from the Florida campaign, as will be described below. To create the two ad groups, the user can use the variables ${Location} and ${Brand} to specify the value for the ad group name field 612. Alternatively, the user can also use the variables ${Campaign} and ${Brand} to specify the value for the ad group name field 612. The other ad group level input fields (e.g., the status field 614, the CPC search bid field 616, the CPC auto placement bid 618, the CPC managed placement bid 620, the max CPM bid 622, and the max CPA bid 624) can be specified in terms of static values.

After the ad group level advertising parameters in the ad group template have been specified, the advertiser can choose to generate the ad group shells based on the ad group template by selecting the user interface element 626 (e.g., a “Generate” button on the user interface 502). In some implementations, to generate the multiple ad group shells, the variables used in the ad group template are processed and a number of unique value combinations are generated based on the values of each of the variables. Since only two variables (“${Location}” and “${Brand}”) are used in the ad group template, there are four unique value combinations: “New York and Toyota”, “New York and Ford”, “Florida and Toyota” and “Florida and Ford”). One ad group shell can be generated for each unique value combination, and a total of four ad group shells can be generated: two shells (e.g., the “Toyota New York” ad group and the “Ford New York” ad group) being assigned to the “New York” campaign and the other two shells (the “Toyota Florida” ad group and the “Ford Florida” ad group) being assigned to the “Florida” campaign.

### II.D.5 Editing Campaign and Ad Group Hierarchies to be Generated Based on Templates

Before generating the campaign shells and the ad group shells, the user can be given an opportunity to preview and edit the campaign and ad group hierarchies that would be generated. The user can eliminate unnecessary campaign and ad group combinations (e.g., the “Florida” and “Ford” combination) that can be generated from the campaign and ad group templates during the preview.

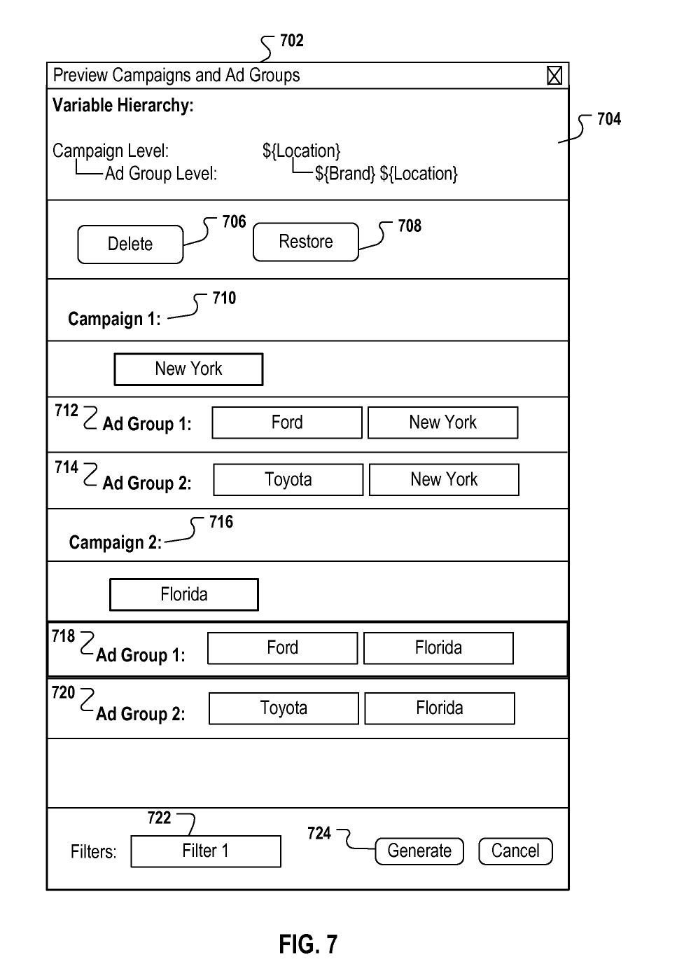

FIG. 7 shows an example user interface 702 for reviewing and editing the campaign shells and ad group shells based on the specified campaign template and ad group template. The user interface 702 can present a variable hierarchy 704 showing the variables used in specifying the campaign level advertising parameters and the variables used in specifying the ad group level advertising parameters. In some cases, the same variable can be used in both the campaign level advertising parameters and the ad group level advertising parameters. In this example, the campaign level advertising parameters are specified using a single variable ${Location}, and the ad group level advertising parameters are specified using two variables ${Brand} and ${Location}. Therefore the variable hierarchy can be expressed as ${Location}→${Location} ${Brand} as shown in FIG. 7.

In some implementations, the user interface 702 can also present a number of unique value hierarchies that are generated based on the variable hierarchy and the different values of the variables in the variable hierarchy. One campaign shell and ad group shell combination can be generated based on each unique value hierarchy.

In this example, four value hierarchies can be generated: “New York”→“Ford” “New York,” “New York”→“Toyota” “New York,” “Florida”→“Ford” “Florida,” and “Florida”→“Toyota” “Florida.” Therefore, the first campaign shell that can be generated using the campaign template and the ad group template is the “New York” campaign 710, including ad groups “Ford New York” 712 and “Toyota New York” 714. The second ad campaign that can be generated is the “Florida” campaign 716, including ad groups “Ford Florida” 718 and “Toyota Florida” 720. These campaign and ad group combinations can be presented on the user interface 702, and the user, after reviewing the set of ad campaign and ad group combinations, can proceed to generate the campaign and ad group combinations by invoking the user interface element 724 (e.g., a “Generate” button).

In some implementations, the user interface 702 can include a user interface element 706 (e.g., a “Delete” button) for deleting a particular value combination to prevent an ad campaign and ad group combination from being generated. In this example, the car dealership does not carry Ford vehicles in Florida. Therefore, the user can select the “Ford Florida” ad group 718 under the “Florida” campaign 716 and remove the “Florida”→“Ford” “Florida” value hierarchy from the list of value hierarchies by invoking the user interface element 706 (e.g., the “Delete” button). Once the value hierarchy is removed from the list of value hierarchies, no campaign and ad group combination will be generated based on the removed value hierarchy.

In some implementations, the removed value hierarchy can still be presented on the user interface 702 even though it is no longer active. The user can restore the deleted value hierarchy by selecting the value hierarchy and invoking the user interface element 708 (e.g., a “Restore” button).

In some implementations, the user interface 702 can allow the user to exclude one or more variable value combinations using a filter document. The advertiser can specifying the unwanted value combinations in the filter document, and select that filter document in the filter field 722. For example, in order to exclude the value combination “Ford” and “Florida,” the filter document can specify ${Brand}${Location}!=[Ford] [Florida]. Based on the filter document, the value hierarchy “Florida”→“Ford” “Florida” can be excluded when campaign and ad group combinations are generated based on the campaign template and the ad group template. In some implementations, the user interface 702 can display the excluded value hierarchies (e.g., as an inactive entry). In some implementations, the user can select one or more of the inactive entries, and activate them individually by invoking the user interface element 708 (e.g., the “Restore” button).

Once the user completes the preview and editing of the value hierarchies that can be generated based on the campaign template and the ad group template, the user can select the user interface element 724 to generate the ad campaign shells including corresponding ad group shells based on the value hierarchies.

In some implementations, to generate the ad campaign shell based on a value hierarchy, the variable advertising parameters in the ad campaign template are evaluated using the variable values included the campaign level of the value hierarchy. Then, the campaign shell is generated according to the invariable advertising parameters and the evaluated variable advertising parameters in the campaign template. Similarly, to generate the ad group shell based on the value hierarchy, the variable advertising parameters in the ad group template are evaluated using the variable values included in the ad group level of the value hierarchy. Then, the ad group shell is generated according to the invariable advertising parameters and the evaluated variable advertising parameters in the ad group template. Ad groups generated from value hierarchies that share a common campaign level value combination are then assigned to the campaign shell that has been generated using the campaign level value combination.

### II.D.6 Specifying an Ad Template and Generating Advertisements Using Variables

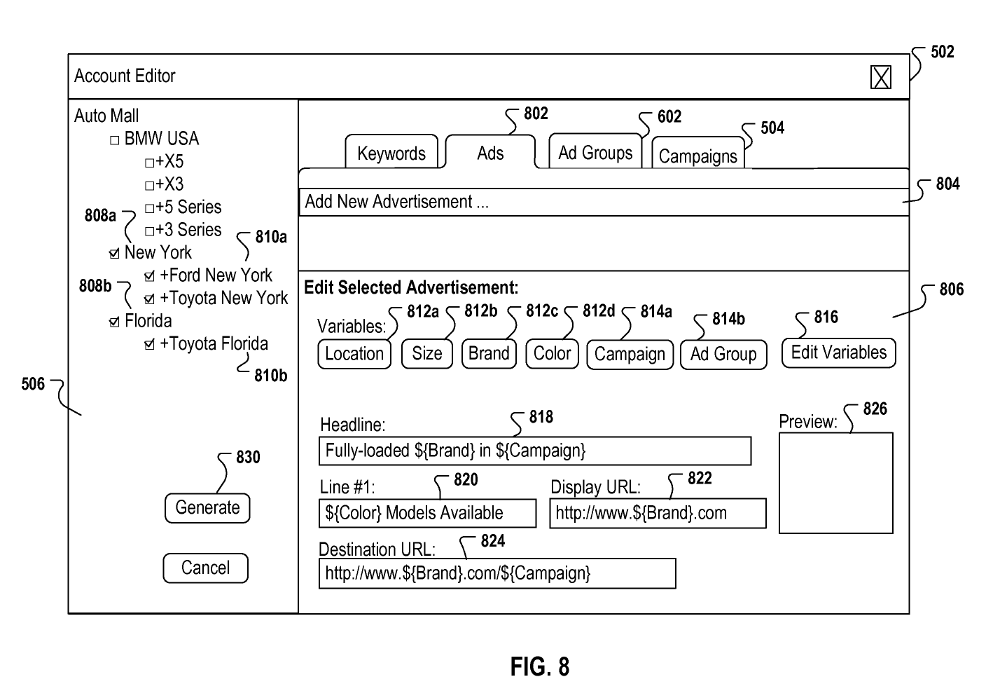

After the user has generated the ad campaign shells with corresponding ad group shells (e.g., through the user interface 702 shown in FIG. 7), the user can proceed to specify advertisements and/or keywords for one or more of the ad campaign shells and ad group shells. FIG. 8 shows an example user interface 802 for specifying an advertisement and/or an advertisement template. Similar to the campaign and ad group specifications, the user can create an advertisement template using some variable advertising parameters and some invariable advertising parameters.

In some implementations, the user interface 802 can include a window 506 which presents existing campaigns and ad groups in the advertising account. The user can select one or more of these campaigns and/or ad groups to add the newly created advertisement template to the selected campaign and/or ad groups. For example, in FIG. 8, the user has selected the newly generated campaign and ad group shells (e.g., campaign “New York” 808a and campaign Florida 808b) (e.g., as indicated by the checkmark next to the campaign names.) When an ad campaign is selected, the ad groups (e.g., ad groups 810a and 810b) included in the selected ad campaigns (e.g., campaigns 808a and 808b) can be automatically selected as well. In some implementations, the user can individually select or unselect one or more of the ad groups by expanding the account hierarchy “Auto Mall” shown in the window 506.

After selecting the ad groups and ad campaigns, the user can invoke a user interface element 804 to create an advertisement for inclusion in each of the selected ad groups in the selected campaigns. After the user invoked the user interface element 804, the user interface 802 can present a number of input fields in the window 806 for the user to enter the advertising parameters for the advertisement. If one or more of the input fields are specified in terms of one or more variables, then an advertisement template can be created, and a number of advertisements can be created based on the advertisement template and the values of the variables used in the advertisement template. Then, the created advertisements are added to the selected ad groups in the selected ad campaigns.

In some implementations, the user interface 802 can include a headline field 818, a first line field 820, a display URL field 822, and a destination URL field 824 for a text ad. In some implementations, the user interface 802 also shows a preview window 826 for the text ad based on the values entered into the input fields.

In some implementations, the user interface 802 also includes a number of user interface elements (e.g., 812a-d and 814a-b) representing the user defined and system defined variables available for specifying the advertisement template. In addition to having the account and campaign level variables available for use in the advertisement template, the user can also create one or more campaign specific variables for each ad campaign, and one or more ad group specific variables for each ad group. In some implementations, the user can invoke a campaign specific variable editing interface for a particular ad campaign by first selecting the ad campaign and then invoke an “Edit Variables” user interface element 816. In some implementations, the user can invoke the campaign specific variable editing interface for a particular ad campaign by right click on the ad campaign to invoke the variable editing interface. An example variable editing interface is shown in FIG. 4.

To create the text ads shown in FIG. 3, the user can first select the New York campaign, and create a first campaign specific variable ${Color}=[executive black, suburban blue], and a second campaign specific variable ${Size}=[mid-size, compact]. The values of these two campaign specific variables are the vehicle colors and sizes available for sale in New York. Similarly, the user can select the Florida campaign, and create a first campaign specific variable ${Color}=[sexy red, canary yellow], and a second campaign specific variable ${Size}=[sports, 4×4]. The values of these two campaign specific variables are the vehicle colors and sizes available for sale in Florida.

In addition, the user can modify the values for the existing campaign level variable ${Brand}, such that the variable adopts an ad group specific value for each ad group in the two ad campaigns “New York” and “Florida.” For example, the user can select the “Toyota New York” ad group and assign an ad group specific value [Toyota] to the variable ${Brand}; select the “Ford New York” ad group and assign an ad group specific value [Ford] to the variable ${Brand}, and selects the “Toyota Florida” ad group and assign an ad group specific value [Toyota] to the variable ${Brand}.

In some implementations, the system defined variables (e.g., ${Campaign} and ${Ad Group}) automatically takes on campaign specific and/or ad group specific values for the ads generated for each campaign and/or ad group. For example, for the advertisements generated for the ad groups in the “New York” campaign, the variable ${Campaign} has a single campaign specific value [New York]; and for the advertisements generated for the ad group in the “Florida” campaign, the variable ${Campaign} has a single campaign specific value [Florida]. Similarly, for the advertisements generated for the ad group “Toyota New York,” the variable ${Ad Group} has a single ad group specific value [Toyota New York], while for the advertisements generated for the ad group “Toyota Florida,” the variable ${Ad Group} has a single ad group specific value [Toyota Florida].

In some implementations, after the variable definitions are completed, the user can specify the advertisement template with the following inputs: Headline: “Fully-loaded ${Brand} in ${Campaign}”; Description: “${Color} ${Size} Models Available”; display URL: “www.${Brand}.com”; and destination URL: “www.${Brand}.com/${Campaign}/.” In this particular example, the headline, description, display URL, and destination URL are all variable advertising parameters that are specified in terms of one or more variables, and in combination with other static text input. In some cases, some advertising parameters can be specified only in terms of variables or only in terms of static values.

Based on the campaign specific and ad group specific definitions for the variables, certain unnecessary advertisements can be eliminated. When the user selects to generate the advertisements based on the advertisement template (e.g., by invoking the user interface element 830), multiple ads can be generated and assigned to their appropriate ad groups based on the campaign specific and ad group specific values for the user-defined and system defined variables. By using the process and variables described above, the text ads and account structure shown FIG. 3 can be generated.

In some implementations, to generate the advertisements based on the variables, the variables in the ad template can be identified first, and then a number of unique value combinations can be determined based on the values for the variables under each ad group. Then, for each unique value combination, an advertisement can be created by evaluating the advertising parameters in the ad template using the variable values in the unique value combination. For example, the variables used in the ad template are ${Brand}, ${Campaign} and ${Color}. To generate the ads for the “Toyota New York” ad group, the variable ${Brand} has a single ad group specific value [Toyota], the variable ${Campaign} has a single ad group specific value [New York], the variable ${Color} has two ad group specific values [executive black, suburban blue], therefore, two unique value combinations can be generated based on the variables and their ad group specific values. The first value combination is ${Brand}=[Toyota], ${Campaign}=[New York], and $Color=[executive black]. The second value combination is ${Brand}=[Toyota], ${Campaign}=[New York], and $Color=[suburban blue]. The first text ad (e.g., Ad 322 shown in FIG. 3) for the ad group “Toyota New York” can be generated by replacing each variable in the ad template with the variable's value in the first value combination. The second text ad (e.g., Ad 324 shown in FIG. 3) for the ad group “Toyota New York” can be generated by replacing each variable in the ad template with the variable's value in the second value combination. Other ads for the other ad groups shown in FIG. 3 can be generated and assigned to their proper ad groups in a similar manner.

In some implementations, a preview interface can be presented showing the variable combination used in the ad template, and the unique value combinations that can be generated from the variable combinations and their campaign and/or ad group specific values. The user can be given an opportunity to preview and exclude certain value combinations from the preview interface, and then generated the advertisements based on the value combinations that are not excluded by the user. In some implementations, the user can also use a filter document to specify the particular variable value combinations that are to be excluded. In some implementations, the preview interface can be similar to that shown in FIG. 7, with the addition of the advertisement level variables shown in the variable hierarchy 704, and the advertisement level variable values shown under each set of the ad group variable values (e.g., ad groups 712, 714, 718, and 720 in FIG. 7).

### II.D.7 Specifying a Keyword Template and Generating Advertisements Using Variables

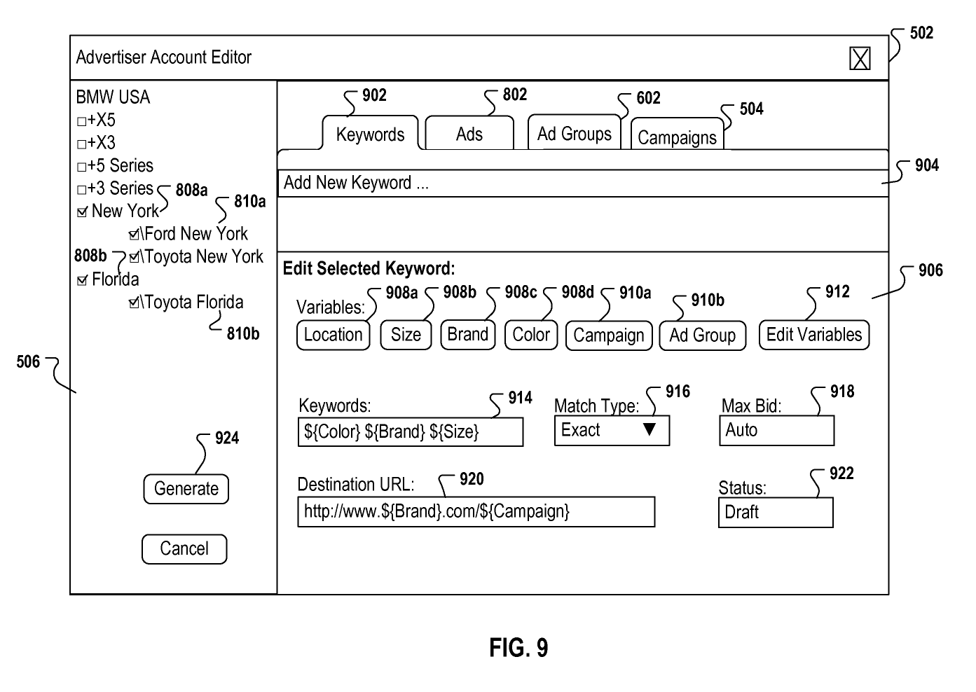

Similar to the advertisements generated for the different ad groups, multiple keywords can be generated for each ad group. FIG. 9 shows an example user interface 902 (e.g., a “Keyword” tab) for specifying a keyword template in the account editor 502. The user can select the user interface element 904 to invoke keyword definition window 906. The keyword definition window 906 can include a number of input fields for the advertising parameters defining the keyword. For example, the keyword definition window 906 can include a keyword field 914, a match type field 916, a max bid field 918, a destination URL field 920, a status field 922, and so on. Other input fields can also be presented. In some implementations, the user interface 902 can also present one or more user interface elements (e.g., user interface elements 908a-d and 910a-b) representing the user-defined and system defined variables available for use in defining the keyword template. In this example, the variables available for specifying the keyword template are the same as those available for specifying the advertisement template. In addition, the campaign specific variable definitions and the ad group specific variable definitions used for the advertisement template are also applicable to the keyword template. Additional campaign specific and ad group specific variables and variable definitions can be created for use in the keyword template (e.g., in a manner similar to that described with respect to the campaign and ad group specific variables used in the ad template).

To create the keyword groups shown in FIG. 3, the user can specify the value for the keyword field 914 in terms of three variables: ${Color} ${Brand} ${Size}. Other keyword level advertising parameters can be specified in terms of static text input or static selection in the appropriate fields (e.g., input fields 916, 918, 920, and 922) in the user interface 802.

Once the user has specified the keyword template, the user can choose to generated the keyword groups for the selected ad campaigns and ad groups. In some implementations, first, the variables used in the keyword template are identified. In this example, the variable combination is ${Color}, ${Brand}, and ${Size}. For each ad group, one or more unique value combinations can be generated from the variable combination and the ad group specific values for the variables in the variable combination. Then, one keyword group can be generated based on each of the unique value combinations by replacing each variable in the keyword template with the value of the variable in the unique value combination.

For example, for the “Toyota New York” ad group, the variable ${Color} has two ad group specific values [executive black, suburban blue], the variable ${Brand} has a single ad group specific value [Toyota], and the variable ${Size} has two ad group specific value [mid-size, compact]. Therefore, four different value combinations can be generated for the ad group “Toyota New York,” including: the first value combination is $Color=[executive black], ${Brand}=[Toyota], ${Size}=[mid-size]; the second value combination is $Color=[executive black], ${Brand}=[Toyota], ${Size}=[compact]; the third value combination is $Color=[suburban blue], ${Brand}=[Toyota], ${Size}=[mid-size]; and the four value combination is $Color=[suburban blue], ${Brand}=[Toyota], ${Size}=[compact]. Therefore, four different keyword groups can be created, each keyword being specified by the invariable advertising parameters in the keyword template and the variable advertising parameters in the keyword template that have been evaluated using the values of the variables in a respective value combination. As a result, the keyword groups 314, 316, 318, and 320 shown in FIG. 3 can be created for the ad group “Toyota New York” under the “New York” campaign.

For another example, for the “Toyota Florida” ad group, the variable ${Color} has two ad group specific values [sexy red, canary yellow], the variable ${Brand} has a single ad group specific value [Toyota], and the variable ${Size} has two ad group specific value [sports, 4×4]. Therefore, four different value combinations can be generated for the ad group “Toyota Florida,” including: the first value combination is $Color=[sexy red], ${Brand}=[Toyota], ${Size}=[sports]; the second value combination is $Color=[sexy red], ${Brand}=[Toyota], ${Size}=[4×4]; the third value combination is $Color=[canary yellow], ${Brand}=[Toyota], ${Size}=[sports]; and the four value combination is $Color=[canary yellow], ${Brand}=[Toyota], ${Size}=[4×r4]. Therefore, four different keyword groups can be created, each keyword being specified by the invariable advertising parameters in the keyword template and the variable advertising parameters in the keyword template that have been evaluated using the values of the variables in a respective value combination. As a result, the keyword groups 340, 342, 3344, and 346 shown in FIG. 3 can be created for the ad group “Toyota Florida” under the “Florida” campaign.

The above examples are illustrative of the processes and user interfaces for creating and modifying variables, as well as the processes and user interfaces for creating and modifying multiple account entries (e.g., campaign shells, ad group shells, advertisements, keywords, etc.) using the variables. Although a specific example account structure is used to facilitate the discussion of the processes and user interfaces, other types of account entries, account structures, variables, and variable definitions can be defined and generated using the methods described herein.

### III. Example Processes for Generating Multiple Account Entries Using Variables

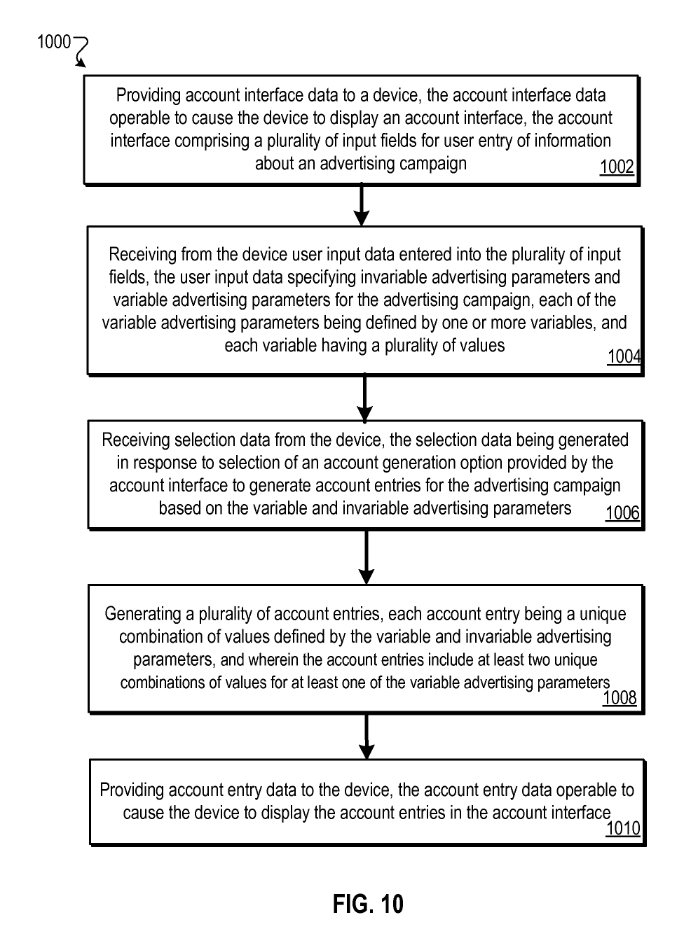

FIG. 10 is a flow diagram of an example process 1000 for generating multiple account entries using variables. The example process 1000 starts when account interface data is provided to a device (1002). The account interface data are operable to cause the device to display an account interface, and the account interface includes a plurality of input fields for user entry of information about an advertising campaign. In some implementations, the account interface includes one or more of the example account interfaces shown FIGS. 4-9. In some implementations, the device is a client device communicating with a remote server providing the account interface data through one or more networks. In some implementations, the device receives the account interface data from a locally executed account management software application. In some implementations, the input fields are those presented for specifying an account entry template, such as a campaign template, an ad group template, an advertisement template, a keyword template, templates for other aspects of an advertising account, or combinations thereof.

Then, user input data entered into the plurality of input fields can be received from the device (1004). The user input data can specify invariable advertising parameters and variable advertising parameters for the advertising campaign. Each of the variable advertising parameters can be defined by one or more variables, and each variable has a plurality of values. In some implementations, the user input data include, for example, the user inputs entered in the various input fields of the user interfaces shown in FIGS. 4-9, for the variable definitions, the campaign template, the ad group template, the advertisement template, and the keyword template, etc.

The process continues when selection data is received from the device (1006). In some implementations, the selection data can be generated in response to selection of an account generation option provided by the account interface to generate account entries for the advertising campaign based on the variable and invariable advertising parameters. The selection data can be user invocation of the “Generate” button on the user interfaces shown in FIGS. 4-9, for example.

In response to receiving the selection data, a plurality of account entries can be generated, where each account entry is a unique combination of values defined by the variable and invariable advertising parameters, and where the account entries include at least two unique combinations of values for at least one of the variable advertising parameters (1008). Generation of the account entries are described in more detail with respect to example account entries and the user interfaces shown in FIGS. 3-9.

After the account entries are generated, account entry data can be provided to the device, where the account entry data are operable to cause the device to display the account entries in the account interface (1010). At this point, the user can see the multiple account entries generated based on the account entry template(s) using the different variable values.

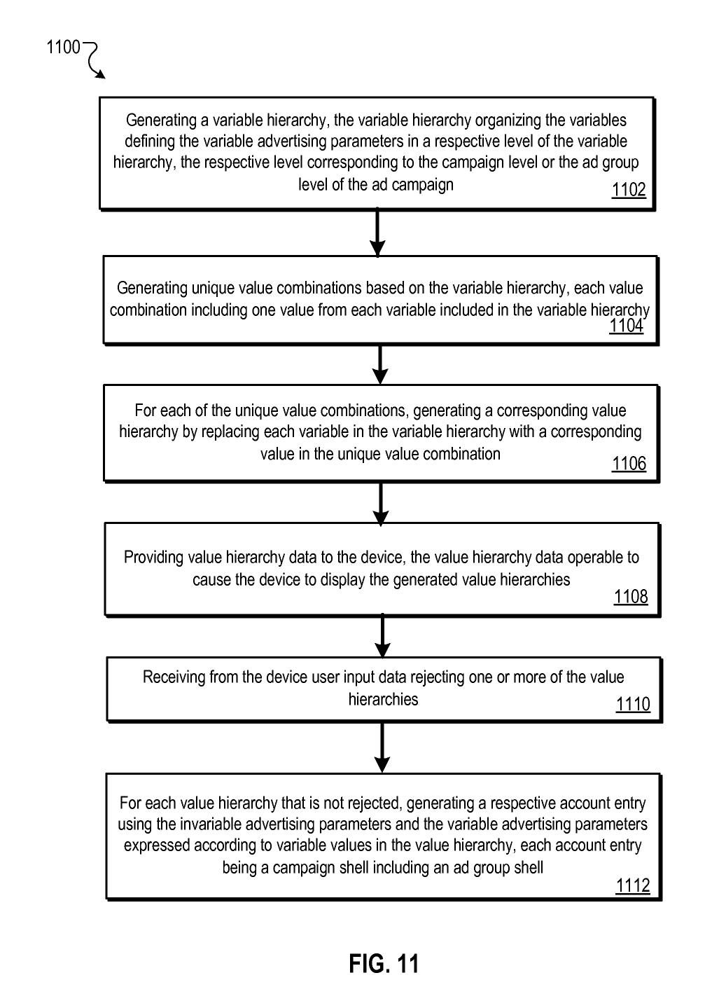

FIG. 11 is a flow diagram of an example process 1100 for presenting campaign and ad group combinations generated using account entry templates and variables. In some implementations, the user can be provided an opportunity to preview the campaign and ad group hierarchies that can be generated based on the campaign template and ad group template. The user can selectively exclude certain campaign and ad group combinations before the campaign shells and corresponding ad group shells are generated.

For example, when the invariable advertising parameters and the variable advertising parameters are specified for a campaign level and an ad group level for the advertising campaign, a variable hierarchy can be generated (1102). The variable hierarchy organizes the variables defining the variable advertising parameters in a respective level of the variable hierarchy, where the respective level corresponds to the campaign level or the ad group level of the ad campaign. An example variable hierarchy is shown in FIG. 7.

Then, multiple unique value combinations can be generated based on the variable hierarchy, where each value combination includes one value from each variable included in the variable hierarchy (1104). For each of the unique value combinations, a corresponding value hierarchy can be generated by replacing each variable in the variable hierarchy with a corresponding value in the unique value combination (1106).

Once the value hierarchies are determined, value hierarchy data can be provided to the device, where the value hierarchy data are operable to cause the device to display the generated value hierarchies (1108). An example user interface displaying the value hierarchies is shown in FIG. 7. In some implementations, the value hierarchies can be combined to show campaign and ad group combinations based on the value hierarchies (e.g., as shown in FIG. 7).

In some implementations, the user interface allows the user to exclude certain the value hierarchies. User input data rejecting one or more of the value hierarchies can be received from the device (1110). Examples of the manners for excluding and restoring one or more value hierarchies are described with respect to FIG. 7.

When the user selects to generate account entries, a respective account entry can be generated for each accepted (i.e., not rejected) value hierarchy (1112). The account entry can be generated using the invariable advertising parameters and the variable advertising parameters expressed according to variable values in the accepted value hierarchy, where each account entry is a campaign shell including an ad group shell. For example, each account entry is generated for each portion of the value hierarchy that is not rejected (or, alternatively, explicitly accepted).

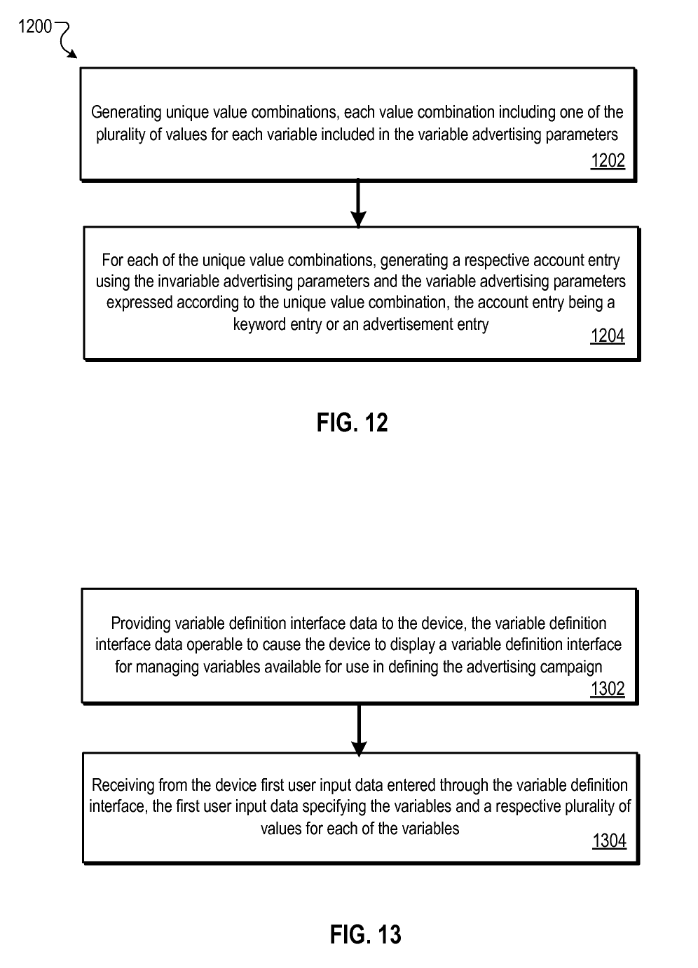

FIG. 12 is a flow diagram of an example process 1200 for generating multiple keywords or advertisements using variables. In some implementations, where the invariable advertising parameters and the variable advertising parameters are specified for a keyword level or an ad level for the advertising campaign, multiple unique value combinations can be generated based on the variables used in the variable advertising parameters (1202). Each unique value combination includes one of the plurality of values for each variable included in the variable advertising parameters. Then, for each of the unique value combinations, a respective account entry can be generated using the invariable advertising parameters and the variable advertising parameters expressed according to the unique value combination, where the account entry is a keyword entry or an advertisement entry. Examples of this process are described with respect to the advertisement and/or keyword generation for the account structure shown in FIG. 3, for example.

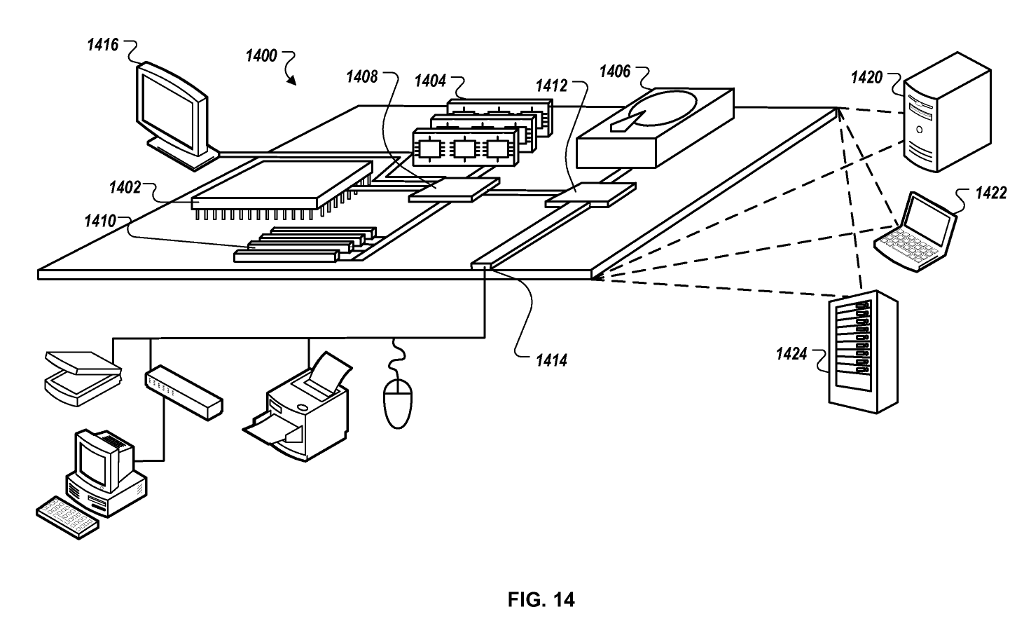

FIG. 13 is a flow diagram of an example process 1300 for obtaining a variable definition. In some implementations, variable definition interface data can be provided to the device, where the variable definition interface data are operable to cause the device to display a variable definition interface for managing variables available for use in defining the advertising campaign (1302). An example of the variable editing user interface is shown in FIG. 4.

First user input data entered through the variable definition interface can be received from the device, the first user input data specifying the variables and a respective plurality of values for each of the variables (1304). Example processes for creating and modifying variables are described with respect to FIGS. 4-9.

In some implementations, the account interface further includes respective user interface elements representing the variables available for use in defining the advertising campaign, and the user input data specify the variable advertising parameters for the advertising campaign includes user selection of the respective user interface elements representing the variables that define the variable advertising parameters. Example user interface elements representing the variables are shown in FIGS. 4-9.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

FIG. 14 is a block diagram of programmable processing system 1400 that may be used to implement the systems and methods described in this document. System 1400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Programmable processing system 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412, are interconnected using various busses, and may be mounted on a common motherboard or in other manners as appropriate. The processor 1402 can process instructions for execution within the system 1400, including instructions stored in the memory 1404 or on the storage device 1406 to display graphical information for a GUI on an external input/output device, such as display 1416 coupled to high speed interface 1408. In other implementations, multiple processors and/or multiple buses may be used, as appropriate, along with multiple memories and types of memory. Also, multiple programmable processing systems 1400 may be connected, with each device providing portions of the necessary operations (e.g., as a server bank, a group of blade servers, or a multi-processor system).

The memory 1404 stores information within the programmable processing system 1400. In one implementation, the memory 1404 is a computer-readable medium. In one implementation, the memory 1404 is a volatile memory unit or units. In another implementation, the memory 1404 is a non-volatile memory unit or units.

The storage device 1406 is capable of providing mass storage for the programmable processing system 1400. In one implementation, the storage device 1406 is a computer-readable medium. In various different implementations, the storage device 1406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1404, the storage device 1406, or memory on processor 1402.

The high speed controller 1408 manages bandwidth-intensive operations for the programmable processing system 1400, while the low speed controller 1412 manages lower bandwidth-intensive operations. Such allocation of duties is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The programmable processing system 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422 or a mobile device (not shown). Alternatively, components from programmable processing system 1400 may be combined with other components in a mobile device (not shown). Each of such devices may contain one or more of programmable processing systems 1400, and an entire system may be made up of multiple programmable processing systems communicating with each other.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
providing account interface data to a device, the account interface data operable to cause the device to display an account interface, the account interface comprising a plurality of input fields for user entry of information about an advertising campaign;
receiving from the device user input data entered into the plurality of input fields, the user input data specifying invariable advertising parameters and variable advertising parameters for the advertising campaign, each of the variable advertising parameters being defined by one or more variables, and each variable having a plurality of values;
receiving selection data from the device, the selection data being generated in response to selection of an account generation option provided by the account interface to generate account entries for the advertising campaign based on the variable and invariable advertising parameters;
in response to receiving the selection data, generating a plurality of account entries, each account entry being a unique combination of values defined by the variable and invariable advertising parameters, and wherein the account entries include at least two unique combinations of values for at least one of the variable advertising parameters; and
providing account entry data to the device, the account entry data operable to cause the device to display the account entries in the account interface.

2. The method of claim 1, wherein the invariable advertising parameters and the variable advertising parameters are specified for a campaign level and an ad group level for the advertising campaign, and wherein generating the plurality of account entries comprises:
generating a variable hierarchy, the variable hierarchy organizing the variables defining the variable advertising parameters in a respective level of the variable hierarchy, the respective level corresponding to the campaign level or the ad group level of the ad campaign;
generating unique value combinations based on the variable hierarchy, each value combination including one value from each variable included in the variable hierarchy; and
for each of the unique value combinations, generating a corresponding value hierarchy by replacing each variable in the variable hierarchy with a corresponding value in the unique value combination.

3. The method of claim 2, further comprising:
providing value hierarchy data to the device, the value hierarchy data operable to cause the device to display the generated value hierarchies; and
receiving from the device user input data rejecting one or more of the value hierarchies.

4. The method of claim 3, wherein generating the plurality of account entries further comprises:
for each value hierarchy that is not rejected, generating a respective account entry using the invariable advertising parameters and the variable advertising parameters expressed according to variable values in the value hierarchy, each account entry being a campaign shell including an ad group shell.

5. The method of claim 1, wherein the invariable advertising parameters and the variable advertising parameters are specified for a keyword level or an ad level for the advertising campaign, and wherein generating the plurality of account entries further comprises:
generating unique value combinations, each unique value combination including one of the plurality of values for each variable included in the variable advertising parameters; and
for each of the unique value combinations, generating a respective account entry using the invariable advertising parameters and the variable advertising parameters expressed according to the unique value combination, the account entry being a keyword entry or an advertisement entry.

6. The method of claim 1, further comprising:
providing variable definition interface data to the device, the variable definition interface data operable to cause the device to display a variable definition interface for managing variables available for use in defining the advertising campaign; and
receiving from the device first user input data entered through the variable definition interface, the first user input data specifying the variables and a respective plurality of values for each of the variables.

7. The method of claim 6, wherein the account interface further comprises respective user interface elements representing the variables available for use in defining the advertising campaign, and wherein the user input data specifying the variable advertising parameters for the advertising campaign comprises data indicating user selections of the respective user interface elements representing the variables that define the variable advertising parameters.

8. A computer-readable medium having instructions stored thereon, which, when executed by at least one processor, cause the processor to perform operations comprising:
providing account interface data to a device, the account interface data operable to cause the device to display an account interface, the account interface comprising a plurality of input fields for user entry of information about an advertising campaign;
receiving from the device user input data entered into the plurality of input fields, the user input data specifying invariable advertising parameters and variable advertising parameters for the advertising campaign, each of the variable advertising parameters being defined by one or more variables, and each variable having a plurality of values;
receiving selection data from the device, the selection data being generated in response to selection of an account generation option provided by the account interface to generate account entries for the advertising campaign based on the variable and invariable advertising parameters;
in response to receiving the selection data, generating a plurality of account entries, each account entry being a unique combination of values defined by the variable and invariable advertising parameters, and wherein the account entries include at least two unique combinations of values for at least one of the variable advertising parameters; and
providing account entry data to the device, the account entry data operable to cause the device to display the account entries in the account interface.

9. The computer-readable medium of claim 8, wherein the invariable advertising parameters and the variable advertising parameters are specified for a campaign level and an ad group level for the advertising campaign, and wherein generating the plurality of account entries comprises:
generating a variable hierarchy, the variable hierarchy organizing the variables defining the variable advertising parameters in a respective level of the variable hierarchy, the respective level corresponding to the campaign level or the ad group level of the ad campaign;
generating unique value combinations based on the variable hierarchy, each value combination including one value from each variable included in the variable hierarchy; and
for each of the unique value combinations, generating a corresponding value hierarchy by replacing each variable in the variable hierarchy with a corresponding value in the unique value combination.

10. The computer-readable medium of claim 9, wherein the operations further comprise:
providing value hierarchy data to the device, the value hierarchy data operable to cause the device to display the generated value hierarchies; and
receiving from the device user input data rejecting one or more of the value hierarchies.

11. The computer-readable medium of claim 10, wherein generating the plurality of account entries further comprises:
for each value hierarchy that is not rejected, generating a respective account entry using the invariable advertising parameters and the variable advertising parameters expressed according to variable values in the value hierarchy, each account entry being a campaign shell including an ad group shell.

12. The computer-readable medium of claim 8, wherein the invariable advertising parameters and the variable advertising parameters are specified for a keyword level or an ad level for the advertising campaign, and wherein generating the plurality of account entries further comprises:
generating unique value combinations, each unique value combination including one of the plurality of values for each variable included in the variable advertising parameters; and
for each of the unique value combinations, generating a respective account entry using the invariable advertising parameters and the variable advertising parameters expressed according to the unique value combination, the account entry being a keyword entry or an advertisement entry.

13. The computer-readable medium of claim 8, wherein the operations further comprise:
providing variable definition interface data to the device, the variable definition interface data operable to cause the device to display a variable definition interface for managing variables available for use in defining the advertising campaign; and
receiving from the device first user input data entered through the variable definition interface, the first user input data specifying the variables and a respective plurality of values for each of the variables.

14. The computer-readable medium of claim 13, wherein the account interface further comprises respective user interface elements representing the variables available for use in defining the advertising campaign, and wherein the user input data specifying the variable advertising parameters for the advertising campaign comprises data indicating user selections of the respective user interface elements representing the variables that define the variable advertising parameters.

15. A system comprising:
one or more processors;
memory coupled to the one or more processors and operable for storing instructions, which, when executed by the one or more processors, cause the one or more processors to perform operations, comprising:
providing account interface data to a device, the account interface data operable to cause the device to display an account interface, the account interface comprising a plurality of input fields for user entry of information about an advertising campaign;
receiving from the device user input data entered into the plurality of input fields, the user input data specifying invariable advertising parameters and variable advertising parameters for the advertising campaign, each of the variable advertising parameters being defined by one or more variables, and each variable having a plurality of values;
receiving selection data from the device, the selection data being generated in response to selection of an account generation option provided by the account interface to generate account entries for the advertising campaign based on the variable and invariable advertising parameters;
in response to receiving the selection data, generating a plurality of account entries, each account entry being a unique combination of values defined by the variable and invariable advertising parameters, and wherein the account entries include at least two unique combinations of values for at least one of the variable advertising parameters; and
providing account entry data to the device, the account entry data operable to cause the device to display the account entries in the account interface.

16. The system of claim 15, wherein the invariable advertising parameters and the variable advertising parameters are specified for a campaign level and an ad group level for the advertising campaign, and wherein generating the plurality of account entries comprises:
generating a variable hierarchy, the variable hierarchy organizing the variables defining the variable advertising parameters in a respective level of the variable hierarchy, the respective level corresponding to the campaign level or the ad group level of the ad campaign;
generating unique value combinations based on the variable hierarchy, each value combination including one value from each variable included in the variable hierarchy; and
for each of the unique value combinations, generating a corresponding value hierarchy by replacing each variable in the variable hierarchy with a corresponding value in the unique value combination.

17. The system of claim 16, wherein the operations further comprise:
providing value hierarchy data to the device, the value hierarchy data operable to cause the device to display the generated value hierarchies; and
receiving from the device user input data rejecting one or more of the value hierarchies.

18. The system of claim 17, wherein generating the plurality of account entries further comprises:
for each value hierarchy that is not rejected, generating a respective account entry using the invariable advertising parameters and the variable advertising parameters expressed according to variable values in the value hierarchy, each account entry being a campaign shell including an ad group shell.

19. The system of claim 15, wherein the invariable advertising parameters and the variable advertising parameters are specified for a keyword level or an ad level for the advertising campaign, and wherein generating the plurality of account entries further comprises:
generating unique value combinations, each unique value combination including one of the plurality of values for each variable included in the variable advertising parameters; and
for each of the unique value combinations, generating a respective account entry using the invariable advertising parameters and the variable advertising parameters expressed according to the unique value combination, the account entry being a keyword entry or an advertisement entry.

20. The system of claim 15, wherein the operations further comprise:
providing variable definition interface data to the device, the variable definition interface data operable to cause the device to display a variable definition interface for managing variables available for use in defining the advertising campaign; and
receiving from the device first user input data entered through the variable definition interface, the first user input data specifying the variables and a respective plurality of values for each of the variables.

21. The system of claim 20, wherein the account interface further comprises respective user interface elements representing the variables available for use in defining the advertising campaign, and wherein the user input data specifying the variable advertising parameters for the advertising campaign comprises data indicating user selections of the respective user interface elements representing the variables that define the variable advertising parameters.
